(19) United States
(12) Patent Application Publication
(10) Pub. No.: US 2005/0009492 A1
(43) Pub. Date: Jan. 13, 2005

(54) Device and method for receiving radio signals

(75) Inventors: Thomas Mueller, Ulm (DE); Thomas Eireiner, Laub (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/858,296

(22) Filed: Jun. 1, 2004

(30) Foreign Application Priority Data
Jun. 6, 2003 (DE) 103 26 104.4

(51) Int. Cl. H04B 1/10

(52) U.S. Cl. 455/303; 455/296

(57) ABSTRACT

A receiving device for radio signals, having an antenna unit, a channel-separation unit, and a control unit which is connected to the channel separation unit and is suited for applying a CMA method to separate desired radio signals from cochannel interference; the control unit, in its application of the CMA method, being suited for suppressing cochannel interference that is not attributed to emissions from that signal source which is emitting the desired signals.

This claims the benefit of German Patent Application No. 103 26 104.4, filed Jun. 6, 2003 and hereby incorporated by reference herein.

The present invention is directed to a device and to a method for suppressing interference when receiving radio signals.

### BACKGROUND

A common problem encountered when transmitting radio signals is that the radio signals are often subject to so-called cochannel interference.

This is due to the fact that transmissions of radio emissions within a specific frequency range are subject to interference from unwanted signals occurring in the same frequency range, i.e., in the same channel.

One source of interference often encountered, for example, is that the emissions from one signal source reach a receiver over different paths.

This so-called multipath propagation stems for the most part from a specific signal component reaching the receiver via a direct path, while other signal components, due, for example, to a reflection at specific terrain features, such as steeply rising mountain slopes, reach the receiver via an indirect path and thus, with a slight delay as compared to the directly received signal. The superposition of these two signals results in a clearly degraded reception and, as the case may be, reproduction quality.

One way to resolve this problem provides for reconstructing the signal originally emitted by the signal source using a signal-conditioning method. To this end, so-called equalizers are typically used, which are often implemented as filters, such as FIR (finite impulse response) filters. In this context, the filter properties can be optionally dynamically adapted, thereby enabling an adaptive filter to be realized.

Another possibility for improving signal quality provides for utilizing the constant modulus property that many high-frequency signals possess. In this context, the received signal is conditioned in such a way that the fluctuations in the signal modulus caused by interference in the propagation path are compensated by a suitable method, thereby enabling the original signal to be reconstructed.

Potential and possible applications of the CMA (constant modulus algorithm) method for suppressing interference caused by multipath propagation are thoroughly investigated in the thesis entitled “Untersuchung und Implementierung von Constant Modulus Algorithmen” [Investigation and Implementation of Constant Modulus Algorithms] (TU Dresden 1999; Michael Lohning), which is hereby incorporated by reference herein. The publication entitled “Dithered Signal Error Constant Modulus Algortihm” by P. Schniter and C. R. Johnson, Jr. (prepared for ICASSP-98 1998) is also hereby incorporated by reference herein.

Another significant problem encountered in today's transmission systems is that, because of the sensitivity of the receiver and possible atmospheric or instrumentally induced overreach or overspill, emissions from different signal sources on the same frequencies reach a receiver and cause strong interference there.

### SUMMARY OF THE INVENTION

An object of the present invention is to provide a device and a method which will aid in suppression of interference in the received radio signals.

The present invention provides a receiving device for radio signals, which has an antenna unit assigned to it, comprising a channel-separation unit and a control unit connected thereto, which is suited for applying a CMA method to separate desired radio signals from cochannel interference, wherein the control unit, in its application of the CMA method, is suited for suppressing cochannel interference that is not attributed to emissions from that signal source which is emitting the desired signals.

The present invention also provides a method for receiving radio signals, by applying a CMA method, desired radio signals being selected from a channel and co-channel interference being suppressed, wherein by applying the method, cochannel interference is suppressed that is not attributed to emissions from that signal source which is emitting the desired signals.

The receiving device according to the present invention, for radio signals has an antenna unit assigned to it, as well as a channel-separation unit and a control unit connected thereto, which, from the received signal that is further processed by the channel-separation unit, extracts parameters for controlling the channel-separation unit, and on the basis of these parameters, controls the channel-separation unit. In this context, the control unit is suited for applying a CMA method to separate desired radio signals from cochannel interference.

In this connection, the control unit is designed, in particular, in such a way that it is not only suited for suppressing interference that originates from a multipath propagation of radio signals coming from the same signal source, but also for effectively filtering out radio signals from other signal sources in the same frequency range, from the received radio signal.

In this context, the performance capability of the device according to the present invention is clearly improved over conventional receiving devices. In comparison to interference caused by multipath propagation, interference effects caused, for example, by overreach, have an especially disadvantageous effect because the content of the emissions deviates substantially from the content of the desired radio signal, and, as a result, the interference is perceived to a much greater degree. The signal quality perceived by the user is distinctly improved by these interference effects being suppressed very effectively by the receiving device according to the present invention.

An especially successful CMA method has proven to be a so-called normalized CMA method (NCMA), which ensures a particularly effective separation of the desired signals from the cochannel interference. NCMA methods are described for example in “On the Convergence of Normalized Constant Modulus Algorithms for Blind Equalization” (Institut EURECOM 1993) by Constantinos B. Papadias and Dirk T. M. Slock, which is hereby incorporated by reference herein.

In accordance with one advantageous embodiment of the present invention, the control unit is suited for improving the signal quality of received frequency-modulated radio signals. Frequency-modulated radio signals are widely used, for example, in ultra shortwave radio broadcasting. Because of its constant modulus, the frequency-modulated ultra shortwave signal is readily conditioned by application of a CMA method. In this way, one advantageously counters the problem, for example, of car radios in motor vehicles often being considerably interfered with because of cochannel interference caused, for example, by overreach, due, in particular, to superpositioning of the desired radio signal with emissions from other transmitters.

Due to the often frequently changing location of the receiving device, especially in this mobile application, it is of particular interest that the cochannel interference mentioned above be efficiently suppressed in this field of application.

It is especially advantageous to utilize specific signal properties of the desired radio signal to ensure that, in the context of a channel separation, particularly in a mobile application, that the same radio channel is reliably and continuously received by the receiving device, and that the control unit does not control the channel-separation unit in such a way that at any specific point in time, the radio signal from an interfering signal source is erroneously interpreted as a desired radio signal and is processed accordingly. The result would be an abrupt change in the transmitter that is being received, which is undesirable to the user.

In this context, the signal properties may be advantageously utilized to identify the desired radio signal and to ensure its conditioning by the receiving device on a permanent basis.

This effectively prevents sudden changes in the transmitters being received by the receiving device.

To distinguish among the various signals, the signal properties of an FM stereo multiplex signal may be used, in particular. This signal contains the stereo information in such a way that the composite signal from the right and the left stereo channel resides within a frequency range of from 0 to 15 kHz, and the differential signal of the two channels resides within the frequency range of between 23 and 53 kHz. By adding or subtracting these two signals, the signals for the right and left loudspeaker, respectively, may be reconstructed in a stereo receiver. However, knowledge of the phase is needed to recover the differential signal. To this end, it is customary for a so-called pilot tone to be co-transmitted at 19 kHz.

Thus, the phase of the multiplex signal contains information that is characteristic of each transmitter. This may be used in the receiving device according to the present invention to identify the desired radio signal and, thus, to ensure a continuous, lasting reception of the desired transmitter, even given a changing position of the receiving device.

It is especially beneficial in this context that information already contained in the desired radio signal may be used to improve the reception quality, thereby eliminating the need for any measures at the transmitter end.

Analogously, the phase information of the RDS (radio data system) signal may be used to identify the desired radio signal.

An especially simple and thus cost-effective realization of the channel-separation unit provides for using a so-called adaptive filter. These filters are based on the principle of delaying incoming signal components using time-delay elements and of subsequently reuniting them, as weighted components, using so-called filter coefficients. In this way, the signal is equalized in a simple manner, the CMA method being applied to determine the filter coefficients.

It is likewise advantageous for the equalization process to be carried out in the domain of space, particularly using a multi-antenna system realization of the antenna units, having a plurality of individual antennas, i.e., so-called antenna arrays.

In this context, the channel-separation unit may have a weighting device, which weights the signal components originating from the individual antennas and thereby changes the antenna characteristic in the manner that the desired signal is effectively separated from any interference effects, on the basis of the characteristic of the receiving properties of the antenna arrays.

One particular advantage is the possibility of implementing the channel-separation unit in a way that makes possible a combined use of an antenna array and an adaptive filter. In this context, the signals originating from the antenna array and already conditioned by the weighting device are fed to the adaptive filter, which undertakes a further signal conditioning. In the process, it is especially beneficial for the design of the control unit to be such that it is able to control both the adaptive filters as well as the weighting devices, and for the input of the control unit to be connected merely to a cross-point, which is connected in outgoing circuit to the weighting device and the adaptive filter.

In this way, it is merely necessary to feed the resulting output signal from the combined adaptive filter and antenna array to the CMA method being applied in the control unit. Using this signal, with one single application of the CMA method, the control unit generates both the weighting factors for weighting the signal components of the individual antennas of the antenna array, as well as the filter coefficients for the adaptive filter. In this manner, the receiving device according to the present invention is able to be implemented very simply and cost-effectively.

Moreover, the described receiving device is especially suited for use in a multiple-in/multiple-out (MIMO) transmission system.

A transmission system of this kind utilizes the normally interfering influence of the multipath propagation in such a way that the various propagation paths of the radio signals are used as mutually independent transmission paths. Due to the benefits just described when separating different signals on the same frequency, a simple application of the receiving device according to the present invention is possible in a MIMO transmission system.

Many important components of the above described receiving device are able to be simply implemented using software. The software for the CMA method may be implemented, in particular, in an FPGA (field programmable gate array). An FPGA realization has various advantages over the use of a digital signal processor. Thus, the hardware used may be optimized to the particular task and, in this way, favorably implemented. For example, it is conceivable to integrate a modular DSP (digital signal processor) structure in an FPGA, only the necessary commands being used. The modular structure makes it possible to simply augment or modify the applied method.

### BRIEF DESCRIPTION OF THE DRAWINGS

Possible specific embodiments of the present invention are described in the following on the basis of two drawings, whose figures show:

FIG. 1 an exemplary embodiment of a multi-antenna system in the context of FM reception;

FIG. 2 a block diagram for illustrating a joint use of the CMA method for determining the filter coefficients and weighting factors.

### DETAILED DESCRIPTION

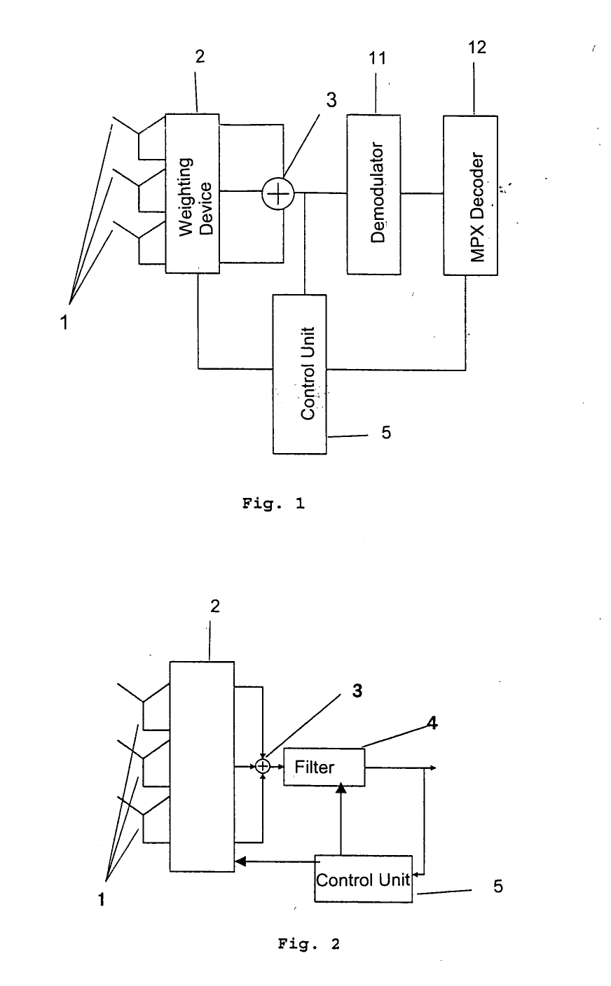

FIG. 1 depicts one implementation of the present invention in a multi-antenna system for stereo FM-reception, using the signal properties of the multiplex signal. In this context, the radio signals are received by antenna array 1 and fed to weighting device 2. Weighting device 2 is linked to adder circuit 3 in which the weighted signal components are summed. The output of adder circuit 3 is linked to the input of demodulator 11, from where the demodulated signals are fed to MPX (multiplex) decoder 12, which recovers the stereo information from the demodulated signal, using the pilot tone.

Control unit 5 controls weighting device 2 by supplying it with weighting factors, on whose basis the signals coming from the individual antennas are combined.

Output signals from adder circuit 3, on the one hand, and output signals from MPX decoder 12, on the other hand, are fed to the input of control unit 5 and are used as input parameters for application of a CMA method. Since the output signals from the MPX decoder contain information on the phase of the pilot tone, they may be used in control unit 5 to ensure that a switch-over to another transmitter is not mistakenly made when applying the CMA method.

FIG. 2 illustrates an exemplary implementation of a joint use of the CMA method. In this context, the radio signals are received by antenna array 1, as in FIG. 1, and fed to weighting device 2. Weighting device 2 feeds the signal components provided with m weighting factors to adder circuit 3 in which the weighted signal components are summed, as already described in reference to FIG. 1. The output of adder circuit 3 is linked to the input of adaptive filter 4. In a further step, adaptive filter 4 undertakes a further signal processing, using n filter coefficients.

The output of adaptive filter 4 is linked to the input of control unit 5. Thus, the signal resulting from the weighting, with subsequent adaptive filtering, is used as the input variable for control unit 5. From this resulting signal, the n filter coefficients, as well as the m weighting factors are calculated in control unit 5 in one and the same application of the CMA method, and fed to weighting device 2 and to adaptive filter 4, respectively.

1. A receiving device for radio signals comprising:
an antenna unit;
a channel separation unit connected to the antenna unit; and
a control unit connected to the channel separation unit, the control unit capable of applying a CMA method to separate desired radio signals from cochannel interference;
the control unit during application of the CMA method being capable of suppressing cochannel interference not attributed to emissions from the signal source emitting the desired radio signals.

2. The receiving device for radio signals as recited in claim 1 wherein the desired radio signals are frequency-modulated or phase-modulated signals.

3. The receiving device for radio signals as recited in claim 1 wherein the desired radio signals exhibit a specific signal property, and the control unit is capable of identifying the specific radio signals on the basis of the specific signal property.

4. The receiving device for radio signals as recited in claim 3 wherein the signal property is phase information of a pilot tone of an FM-stereo multiplex signal or a phase information of an RDS signal.

5. The receiving device for radio signals as recited in claim 1 wherein the channel-separation unit includes an adaptive filter.

6. The receiving device for radio signals as recited claim 1 wherein the antenna unit has a plurality of individual antennas, and the channel-separation unit has a weighting device for weighting signal components originating from the plurality of individual antennas.

7. The receiving device for radio signals as recited in claim 6 wherein the channel-separation unit includes an adaptive filter and wherein the control unit is suited for controlling both the adaptive filter as well as the weighting device, an input of the control unit being connected to a cross-point, the cross-point being downstream of the weighting device and the adaptive filter.

8. A multiple-in/multiple-out transmission system comprising a receiving device for radio signals having an antenna unit; a channel separation unit connected to the antenna unit; and a control unit connected to the channel separation unit, the control unit capable of applying a CMA method to separate desired radio signals from cochannel interference; the control unit during application of the CMA method being capable of suppressing cochannel interference not attributed to emissions from the signal source emitting the desired radio signals.

9. A method for receiving radio signals comprising:
selecting desired radio signals from a channel using a CMA method so that co-channel interference is suppressed not attributed to emissions from a signal source emitting the desired radio signals.

10. The method as recited in claim 9 wherein the desired radio signals are frequency-modulated or phase-modulated signals.

11. The method as recited in claim 9 wherein the desired radio signals exhibit specific signal properties and are identifiable on the basis of the specific signal properties.

12. The method as recited in claim 11 wherein the specific signal property is phase information of a pilot tone of an FM-stereo multiplex signal or a phase information of an RDS signal.

13. The method as recited in claim 9 wherein the desired radio signals are selected in a filtering process using an adaptive filter.

14. The method as recited in claim 9 wherein the radio signals are received by various individual antennas, and output signals from the individual antennas undergo a controlled weighting to select the desired radio signals.

15. The method as recited in claims 14 wherein the desired radio signals are selected in a filtering process using an adaptive filter and the filtering and the weighting are controlled in one single application of the CMA method, and input parameters for the CMA method are obtained from a further signal resulting from the filtering and the weighting operations.

16. The method as recited in claim 9 wherein the method is capable of selecting the desired radio signals in a multiple-in/multiple-out (MIMO) transmission system.
